(19) United States
(12) Patent Application Publication
(10) Pub. No.: US 2018/0335017 A1
(43) Pub. Date: Nov. 22, 2018

(54) WIND TURBINE GENERATOR CONTROL METHOD AND SYSTEM

(71) Applicant: VESTAS WIND SYSTEMS A/S, Aarhus N (DK)

(72) Inventors: John Godsk NIELSEN, Hornslet (DK); Duy Duc DOAN, Tilst (DK); Søren ANDERSEN, Tilst (DK); Gert Karmisholt ANDERSEN, Hovedgård (DK)

(21) Appl. No.: 15/777,795

(22) PCT Filed: Dec. 1, 2016
(86) PCT No.: PCT/DK2016/050407

§ 371 Date: May 21, 2018

(30) Foreign Application Priority Data
Dec. 3, 2015 (DK) PA 2015 70795

(51) Int. Cl. F03D 7/04; F03D 7/02; H02J 3/38; H02M 5/458

(52) U.S. Cl. CPC F03D 7/042; F03D 7/0264; F05B 2270/3201; H02J 3/386; H02M 5/4585; F03D 7/026

(57) ABSTRACT

A method for controlling a wind turbine system including an electrical generator, a power converter system, a DC-link, and at least a grid-side breaker arrangement controllable between open and closed states, wherein the method comprises monitoring for the presence of a shutdown event and, in response to identifying the presence of a shutdown event, controlling the wind turbine into a production-ready state, comprising: i) controlling the grid-side breaker arrangement in the closed state; ii) disabling one or more drive signals to the power converter system; and iii) controlling the DC-link of the power converter system in a charged state. Advantageously, this approach reduces the frequency of use of the grid-side breaker arrangement which extends serviceable life considerably, and also allows the wind turbine system to be transitioned rapidly between an operating state and a production-ready state.

### TECHNICAL FIELD

Aspects of the invention relate generally to a method and system for controlling a wind turbine system in order to improve grid connectivity.

### BACKGROUND OF THE INVENTION

Wind turbine generators capture and convert wind energy into electrical energy for transmission to an electrical power grid. A typical wind turbine generator comprises a tower which forms the support structure for the wind turbine generator, a nacelle which contains the power generating components and a rotor, formed of a hub and a plurality of wind turbine blades, which is rotatably attached to the nacelle. The mechanical energy produced by the rotor is converted to electrical energy by an electrical generator housed in the nacelle. The electrical energy produced by the electrical generator has an AC voltage/current with a frequency dependent on the speed of rotation of the rotor and hence on the wind speed. For integration with the grid, this variable frequency AC voltage/current must be converted to a controllable frequency AC voltage/current. This step is undertaken by a power converter.

A relatively recent development in wind turbine generator power control is a so-called full scale power converter which gives full control of the voltage/current of the energy generated by the wind turbine generator before injection into the grid. A typical full-scale power converter comprises a generator-side converter for regulating the power of the electrical generator, a grid-side converter for regulating the power injected into the grid, and a DC-link for coupling of the two converters. Circuit breakers are located between the electrical generator and the generator-side converter and also between the grid-side converter and the grid.

In some circumstances a wind turbine generator (WTG) is required to stop providing power to the grid. One example is where the wind speed is too low for the electrical generator to function so the wind turbine generator must be shut down until wind conditions have improved. Another example is where a wind turbine generator is required to provide so-called ‘spinning reserve capacity’ in order that an associated wind park may conform to grid code requirements for providing voltage and frequency control to the grid.

In both of these circumstances, a known grid connection control approach is that the wind turbine generator will be operated in a controlled shut down regime which involves opening the generator breakers and the grid breakers, and also discharging the DC-link. When the wind turbine generator is required to resume power generation, it may be operated in a controlled start-up regime in which the DC-link is charged, and the breakers closed, before activating the converters.

### SUMMARY OF ASPECTS OF THE INVENTION

A disadvantage of the grid connection control approach mentioned above is that carrying out a controlled shut down results in a delay before power can be provided to the grid during a controlled start-up. It is against this background that the embodiments of invention have been devised.

In a first aspect, the embodiments of the invention provide a method for controlling a wind turbine system including an electrical generator, a power converter system including a DC-link, and at least a grid-side breaker arrangement controllable between open and closed states, wherein the method comprises:
monitoring for the presence of a shutdown event and, in response to identifying the presence of a shutdown event, controlling the wind turbine system into a production-ready state, comprising:
   i) controlling the grid-side breaker arrangement in the closed state;
   ii) disabling one or more drive signals to the power converter system; and
   iii) maintaining the DC-link of the power converter system in a charged state.

In another aspect, the embodiments of the invention provide in a wind turbine system comprising an electrical generator, a power converter system including a DC-link, a grid-side breaker arrangement controllable between open and closed states, and a control system configured to control the wind turbine system from an operating state to a production-ready state by:
i) controlling the grid-side breaker arrangement in the closed state;
i) disabling one or more drive signals to the power converter system; and
ii) maintaining the DC-link of the power converter system in a charged state.

In some embodiments the wind turbine system may also include a generator-side breaker arrangement controllable between open and closed states. Furthermore, a rotor of the wind turbine system may be controlled so that it is kept spinning during and after the shutdown event.

In general, the electrical generator is connectable, or arranged to be coupled, to a power grid (or electrical grid) via or by means of the power converter system and optionally, in addition thereto, via additional electrical equipment. In general, the power converter system is arranged to be coupled to the electrical generator and arranged to be coupled to the power grid. In general, the grid-side breaker arrangement is located between the power converter system and the power grid in order to control connection, e.g. to connect and/or disconnect, of the power converter system to the power grid. In general, the generator-side breaker arrangement is located between the electrical generator and the power converter system to control connection, e.g. to disconnect and/or connect, of the electrical generator to the power converter system.

A benefit of the embodiments of the invention is to allow the wind turbine system to be rapidly transitioned between an operating state and a production-ready state, simply by disabling and enabling the power converter system as required, whilst the DC-link is kept or controlled or maintained at a charged operational level, and the grid-side and the generator-side breakers remain closed. Advantageously, this approach also reduces the frequency of use of the grid-side and generator-side breakers which extends their serviceable life considerably. This is a benefit particularly when wind turbine generators are in off shore locations where maintenance is a much more difficult and expensive process.

Following a shutdown event, and, in response to identifying the presence of a startup event, the wind turbine system may be controlled into an operating state comprising i) controlling the grid-side breaker arrangement in the closed state and ii) enabling one or more drive signals to the power converter system.

In some embodiments, the shutdown event may be triggered by a low wind condition. In other embodiments, the shutdown event may be triggered by a spinning reserve requirement.

Disabling of the one or more drive signals to the power converter system may involve disabling a pulse-width modulated drive signal to a generator-side converter and to a grid-side converter. Similarly, enabling the one or more drive signals to the power converter system may involve enabling a pulse-width modulated drive signal to a generator-side converter and to a grid-side converter.

Aspects of the invention may also be expressed as a controller comprising a processor, a memory module, and an input/output system, wherein the memory module includes a set of program code instructions which, when executed by the processor, implements a method as described above, and also as a computer program product downloadable from a communication network and/or stored on a machine readable medium, comprising program code instructions for implementing a method as described above, and also as a machine readable medium having stored thereon such a computer program product.

For the purposes of this disclosure, it is to be understood that the control system described herein can comprise a control unit or computational device having one or more electronic processors. Such a system may comprise a single control unit or electronic controller or alternatively different functions of the controller(s) may be embodied in, or hosted in, different control units or controllers. As used herein, the term “control system” will be understood to include both a single control unit or controller and a plurality of control units or controllers collectively operating to provide the required control functionality. A set of instructions could be provided which, when executed, cause said controller(s) or control unit(s) to implement the control techniques described herein (including the method(s) described below). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on or more electronic processors, optionally the same one or more processors as the first controller. It will be appreciated, however, that other arrangements are also useful, and therefore, the aspects of the invention are not intended to be limited to any particular arrangement.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

In order for the inventive concept to be better understood, specific embodiments will now be explained by way of example with reference to the accompanying drawings, in which:

FIG. 1 is a schematic view of a wind power plant;

FIG. 2 is a schematic system diagram of a wind turbine system;

FIG. 3 is a flow chart of a method of controlling the wind turbine system during a change of operational state according to an embodiment of the invention;

FIG. 4 is a chart illustrating the operational states of components of the wind turbine system, when controlled by the method of FIG. 3;

FIG. 5 is a flow chart of a method of controlling the wind turbine system during a change of operational state according to another embodiment of the invention; and

FIG. 6 is a chart illustrating the operational states of components of the wind turbine system, when controlled by the method of FIG. 5.

### DETAILED DESCRIPTION OF EMBODIMENTS

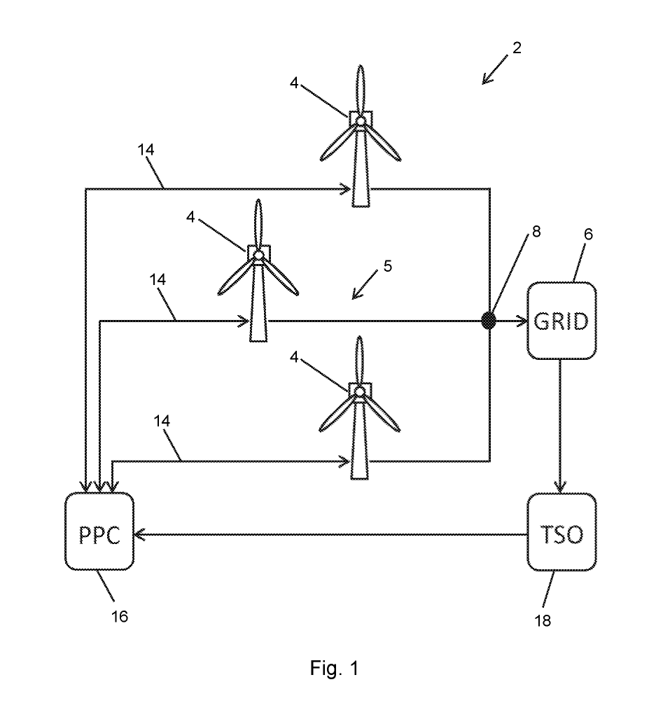

FIG. 1 shows the general structure of a wind power plant 2 in which the aspects of the invention may be implemented. The wind power plant 2 comprises a plurality of wind turbine systems or ‘generators’ 4 which provide energy to an electrical grid or power grid 6. Each of the wind turbine generators (WTGs) 4 is a horizontal axis wind turbine generator (HAWT), although it should be appreciated that the aspects of the invention are also applicable to other types of wind turbine generators.

As is conventional, the power outputs of the wind turbine generators 4 are interconnected via an internal grid 5 at a point of common coupling 8, which feeds an external power grid 6.

Note that the point of common coupling 8 may also be referred to herein as ‘CC’ for brevity. The power grid 6 therefore receives power from the wind power plant 2 that is a combination of the outputs from all of the wind turbine generators 4 in the power plant 2. It will be appreciated that the electrical power generated by the wind turbine generators 4 depends on the wind energy available in the locality of each of those wind turbine generators 4, since the wind speed typically varies from location to location across the power plant 2.

The wind turbine generators 4 form part of an industrial control system and, as such, are connected together by a communications network 14. The communications network 14 enables each of the wind turbine generators 4 to communicate bi-directionally with a power plant controller (PPC) 16. Such a communications network 14 is conventional in wind power plants 2 featuring modern utility-scale wind turbine generators 4 so a detailed explanation will not be given here. However, it should be understood that the communications network 14 enables the wind turbine generators 4 to feed operational data to the power plant controller 16, and enables the power plant controller 16 to transmit control commands and other data to each of the wind turbine generators 4, either on a basis of general broadcast transmissions (same data for all wind turbine generators 4) or directed transmissions (commands/data tailored to specific wind turbine generators 4).

In the embodiment of FIG. 1, the communications network 14 is depicted as lines, which suggests a cable-based infrastructure. Although a cable-based infrastructure is acceptable, it should be noted that this is not to be considered limiting and, as such, the communications network 14 may be embodied as a wireless system. Typically, communications protocols for such control systems are standardized by equipment vendors, examples of which are governed by IEC 60870-5-101 or 104, IEC 61850 and DNP3. However, alternative protocols such as TCP/IP may also be used.

An important function of the power plant controller 16 is to provide each of the wind turbine generators 4 with power reference values which dictate the maximum power level or ‘power limit’ at which the wind turbine generators 4 should operate, referred to by the variables P_{REF} and Q_{REF}. The power plant controller 16 may also command the wind turbine generators 4 to transition between an operating state, in which the wind turbine generators 4 generate power, and a non-operating state, in which the wind turbine generators 4 do not generate power.

The power plant controller 16 determines P_{REF} and Q_{REF} based on several factors, including: the operational status of the wind turbine generator 4; the grid status, and the power demand as provided by a transmission system operator (TSO), labelled here as 18. Overall, the power plant controller 16 will operate the wind turbine generators 4 so that the power produced by the wind power plant 2 as a whole meets the power demanded by the TSO 18. In doing so, the power plant controller 16 determines specific power reference values in respect of each of the wind turbine generators 4 in the wind power plant 2. This ensures that power production from the wind power plant 2 can be optimised to take account of varying conditions.

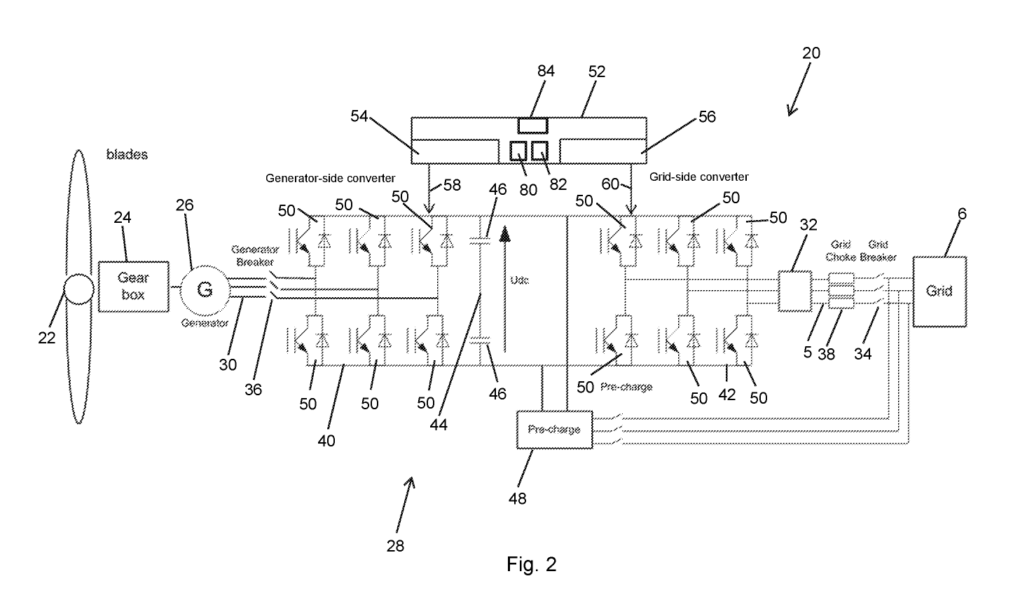

Having described the overall arrangement of the wind power plant 2, the following description will now focus on the more detailed structure of the wind turbine generators 4. For the purposes of this description, all of the wind turbine generators 4 can be considered to be substantially identical although it will be appreciated that this is not essential. With this in mind, FIG. 2 shows an example of a wind turbine system 20 which gives context to the illustrated embodiments of the invention, as will become apparent. Represented schematically as a system diagram the wind turbine system 20 includes features that are significant for this discussion, but it should be appreciated that other conventional features are not shown here for brevity, for example yaw control equipment, control network, local power distribution network and so on. However, the skilled person would understand that these features would be present in a practical implementation. Also it should be noted that the specific architecture discussed here is used as an example to illustrate the technical functionality of the embodiments of the invention, and so the embodiments may be implemented by a system having a different specific architecture.

With reference to FIG. 2, the wind turbine system 20 includes a bladed rotor 22, which drives a transmission 24. Although the transmission 24 is shown here in the form of a gearbox, direct-drive architectures are known which do not include a gearbox. The transmission 24 drives an electrical generator 26 for generating electrical power. Three-phase electrical power generation is usual in utility scale wind turbine systems, but this is not essential for the purpose of this discussion.

In general, the electrical generator 26 is connectable, or arranged to be coupled, to the power grid 6 via or by means of a power converter system 28 and optionally, in addition thereto, via additional electrical equipment. In general, the power converter system 28 is arranged to be coupled to the electrical generator 26 and arranged to be coupled to the power grid 6. The electrical generator 26 may be connected to the power converter system 28 by a suitable three-phase electrical connector such as a cable or bus 30. The power converter system 28 may be of a conventional architecture and, as is known, converts the output frequency of the electrical generator 26 (an AC signal) to a suitable output voltage level and frequency (also an AC signal) that is suitable for supplying to an internal electrical grid 5 via a transformer 32. A first (grid-side) breaker arrangement 34 is located between the power converter system 28 and the power grid 6 in order to control connection, e.g. to connect and/or disconnect, of the power converter system 28 to the power grid 6, and a second (generator-side) breaker arrangement 36 may be located between the electrical generator 26 and the power converter system 28 to control connection, e.g. connect and/or disconnect, of the electrical generator 26 to the power converter system 28.

A grid choke 38 is located between the power converter system 28 and the grid-side breaker arrangement 34 to remove high frequency switching characteristics from the voltage waveform output by the transformer 32.

It will be appreciated that the specific architecture described here is a two-level back-to-back voltage source full scale power converter system (FSC) system 28, which includes a generator-side converter 40 and a grid-side converter 42 which are coupled via a DC-link 44. The DC-link 44 comprises capacitors 46 which act to smooth out the voltage ripple in the output of the generator-side converter 40. A DC-link pre-charge unit 48 is connected to the DC-link 44 and is operable to charge the DC-link 44 to a voltage level that enables the converter 28 to operate correctly. Such a pre-charge unit 48 is conventional and will not be described in further detail here. The pre-charge unit 48 is powered by a suitable power feed taken from the grid side of the power converter system 28.

As is conventional, the generator-side converter 40 and the grid-side converter 42 comprise a plurality of semiconductor switches 50, which in this case are insulated gate bipolar transistors (IGBTs), but other switching devices may be used. In this embodiment, the converters 40, 42 comprise six semiconductor switches 50 but other full-scale converter configurations would be understood by the skilled person. Together, the generator-side converter 40 and the grid-side converter 42 are responsible for converting one or more AC voltage signals to a DC voltage signal and then to convert the DC voltage signal back again to one or more AC voltage signals. More specifically, the AC voltage signal(s) from the electrical generator 26 are converted by the generator-side converter to a DC voltage signal on the DC link, which is then converted by the grid-side converter back to an AC voltage signal(s). However, it is normal, under certain conditions, for wind turbine generators to be supplied with power from the power grid, and then the grid-side converter would convert AC signals to DC signals, and the generator-side converter would convert DC signals to AC signals.

In order to achieve power control objectives, the wind turbine system 20 is equipped with a wind turbine control system, or more simply ‘controller’ 52 that is operable to control the power converter system 28 appropriately. The wind turbine controller 52 may be implemented in any combination of hardware, software and/or firmware to provide a suitable processor 80, memory module 82 and input/output system 84. The processor 80 may be configured to carry out a set of program code instructions stored on the memory module which may implement a method as described herein, and as will become apparent in the foregoing description.

As part of this, the wind turbine controller 52 includes a generator-side converter drive module 54 and a grid-side converter drive module 56. Here the drive modules 54, 56 are shown as being integrated into the wind turbine controller 52, but it should be noted that the drive modules 54, 56 may also be separate hardware units. The wind turbine controller 52 is also responsible for issuing control commands to other parts of the system, for example the pre-charge unit 48 and the grid-side and generator-side breaker arrangements 34, 36.

The generator-side converter drive module 54 provides suitable drive signals 58 to the control gates of the semiconductor switches 50 of the generator-side converter 40 in order to convert the alternating voltage generated by the electrical generator 26 to a substantially constant voltage on the DC-link 44 at a predetermined voltage level.

Similarly, the grid-side converter drive module 56 provides suitable drive signals 60 to the control gates of the semiconductor switches 50 of the grid-side converter 42 in order to convert the substantially constant voltage on the DC-link 44 to an alternating voltage at a predetermined voltage level and frequency.

As would be known to the skilled person, the drive signals 58, 60 sent to the generator-side converter 40 and the grid-side converter 42 may be any suitable drive signal, one example of which is a pulse-width modulated (PWM) drive signal, but other drive signal types could also be used. The drive signals 58, 60 may be enabled by the respective converter drive modules 54, 56 in order to transfer energy across the associated converter 40, 42. Likewise, the drive signals 58, 60 may be disabled by the respective converter drive modules 54, 56 in order to prevent the transfer of energy across the associated converter 40, 42.

The wind turbine system 20 described above may be controlled in an operating state in order to provide power to the grid 6 at a predetermined voltage and frequency. It is common for a wind turbine system 20 to spend the majority of its lifetime in the operating state in order to generate as much power as possible from a renewable energy resource. However, there are some circumstances where it is necessary for the wind turbine system 20 to transition from the operating state to a non-operating state in which it does not supply generated power to the grid 6. Such a non-operating state may also be referred to as a shutdown state, or non-power producing state. Similarly, transitioning from the operating state into the non-power producing state may be commanded by a suitable request from the power plant controller, which may be referred to as a shutdown ‘event’ or ‘request’, but may also be referred to by other terms such as a pause request.

Two examples of scenarios in which the wind turbine system 20 would be in a non-operating state are in a low wind situation, where the speed of the wind is insufficient for energy production, and when the wind turbine system 20 is being held as a spinning reserve for the wind power plant 2. The spinning reserve of the wind power plant 2 is the reserve power supply which can be utilised if, for example, the grid 6 experiences an unexpected surge in demand or a fault takes a wind turbine generator 4 offline.

Conventionally the wind turbine system 20 can be transitioned from a non-operating to an operating state by charging the DC-link 44 to a predetermined voltage level, closing the grid-side and generator-side breaker arrangements 34, 36 and enabling the drive signals 58, 60 of the respective converter drive modules 54, 56.

In one embodiment of the invention a control technique is provided for bringing the spinning reserve of the system online or offline. In these circumstances it is desirable to be able to transition the wind turbine system 20 from a non-operating state to an operating state as quickly as possible in order to meet grid requirement with minimal disruption. However, this requirement is compromised by the time taken to activate the breaker arrangements 34, 36, recharge the DC-link 44 and so on.

The aspects of the invention provide a method for controlling the wind turbine system 20 which provides a solution to this problem. This is achieved by controlling the grid-side and generator-side breaker arrangements 34, 36 in a closed state, and the DC-link 44 is controlled so as to be charged to a predetermined voltage level when the wind turbine system 20 is in a non-operating, but production-ready, state. In the present context, the term ‘controlling’ covers the situation in which the grid-side breaker arrangement and generator-side breaker arrangements are left, or ‘managed’ or ‘maintained’ or ‘retained’ in their closed state, although suitable status checks may be carried out to confirm the state and function of the breaker arrangements. This is in contrast to the conventional approach in which the grid-side and generator-side breaker arrangements 34, 36 are open, and the DC-link 44 discharged when the wind turbine system 20 is in a non-operating state. An advantage of the method of the embodiments of the invention is that the wind turbine system 20 can be rapidly transitioned from a non-operating state to an operating state, simply by enabling the converters 40, 42.

The discussion will now focus on two specific implementations of the control method.

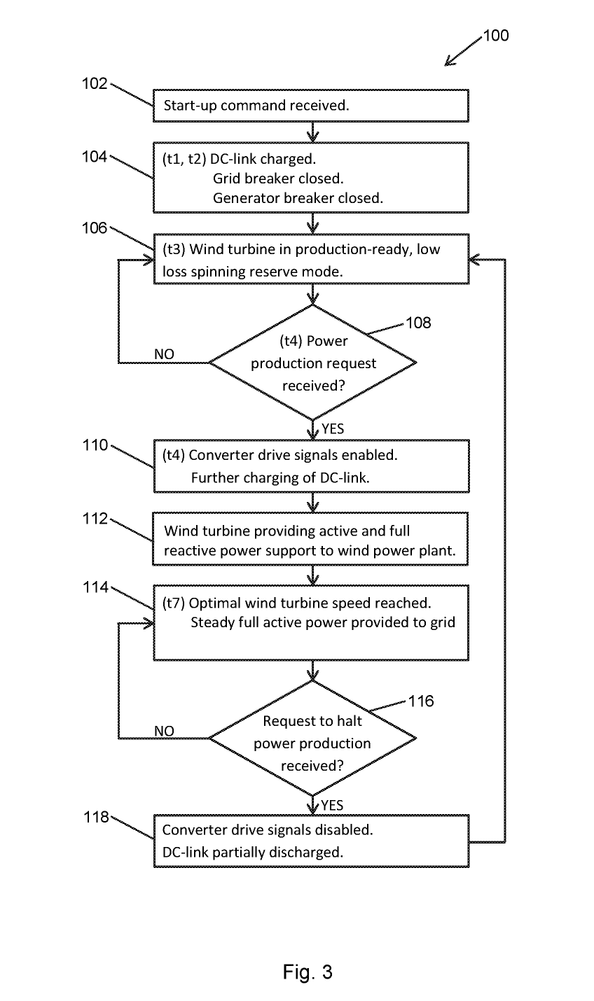

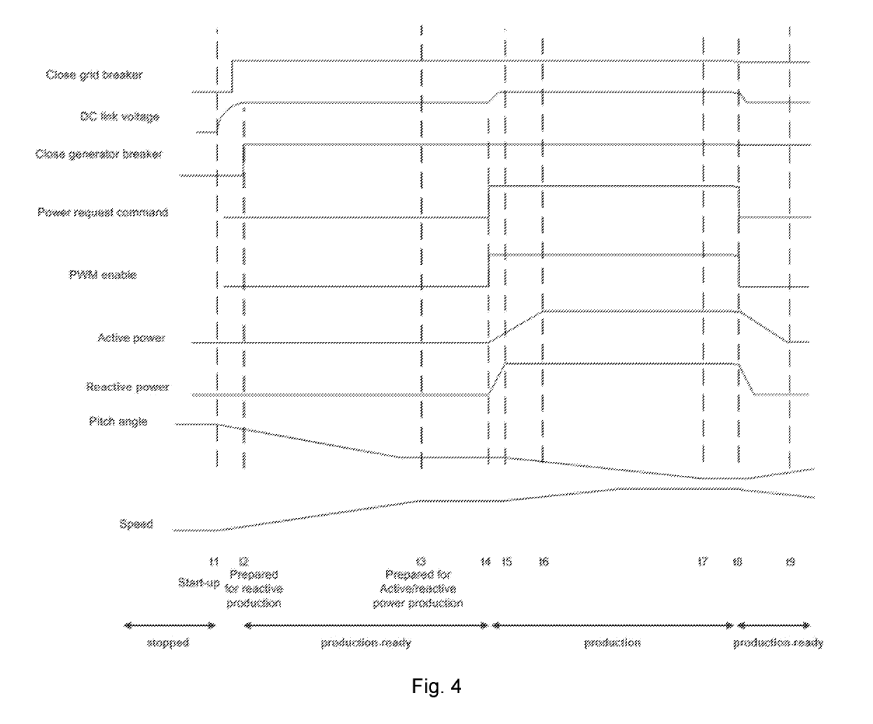

Firstly, FIGS. 3 and 4 illustrate how the control method is implemented in a first embodiment of the invention, so as to provide a wind power plant 2 with a rapidly responding spinning reserve. More specifically, the wind turbine system 20 is illustrated transitioning from a production-ready state to an operating state, and then back to a production-ready state.

With reference to FIG. 3, the process 100 is initiated by the wind turbine controller 52 receiving a start-up command at step 102, which may be sent to it by the power plant controller. At step 104, following receipt of the start-up command, the wind turbine controller 52 transmits control signals to initiate charging of the DC-link 44 to a predetermined level by the DC-link pre-charge unit 48, and to control the grid-side and generator-side breaker arrangements 34, 36 into a closed state. This can be seen on FIG. 4 between t1 and t2 in which the states of the breakers 34, 36 changes from closed to open and the DC-link voltage rises to an operational level which may be at a level proportional to the peak line-to-line voltage of the grid.

Operational data is continuously received by the wind turbine controller 52 from sensors on the wind turbine generator 4 and the rotor speed is controlled such that the wind turbine system 20 is ready to provide active power if requested. At step 106, the rotor speed is further controlled until it reaches a level sufficient for significant active power production if requested. The wind turbine system 20 is now operating in a production-ready, low loss spinning reserve, mode, as can be seen in FIG. 4 between t2 and t4. This means that although the wind turbine system 20 is in a non-operating state where power is not being supplied to the grid 6, it is ready to rapidly transition to an operating state when requested.

At decision step 108 the wind turbine controller 52 monitors for receipt of a power production request, which is a request for the wind turbine system 20 to transition from a production-ready state to an operating state where active and reactive power support is supplied to the wind power plant 2. If a power production request is not received by the wind turbine controller 52, the process returns to step 106 and the wind turbine generator 4 remains in a production-ready, low loss spinning reserve, state. However, when a power production request is received, the process moves on to step 110 at which point the wind turbine controller 52 responds by enabling the converter control modules 54, 56 thereby to control energy transfer across the associated converters 40, 42. At this point, the DC-link 44 may undergo further charging in order for the grid-side converter to have full control of the power flow from the DC-link. Here, the DC-link voltage is raised to a level that is slightly higher than the line-to-line peak voltage of the grid. Note that at this point the breaker arrangements are already in the closed position. Thus the control system can be considered to control the breaker arrangements so that they remain in the closed state. This may be in the form of a confirmatory check of the position of the breaker arrangements.

In step 112, and referring also to FIG. 4, at t4 the system brings online production of reactive power and then active power according to the respective power reference values, Q_{ref} and P_{ref} provided to the wind turbine controller 52 until, at t6, the wind power plant 2 is being supplied with full active and reactive power support. From t6 onward, as is indicated at step 114, the wind turbine controller 52 controls the wind turbine system 20 to reach its predetermined rated torque and speed range.

Thereafter, the process enters a monitoring stage, shown at decision step 116, in which the wind turbine controller 52 monitors for receipt of a request to stop power production such that it must transition from an operating state to a production-ready state. Such a request, or event, may be sent by the power plant controller.

The process loops around steps 114 and 116 until a stop production request signal is received which, and until such time the wind turbine system 20 continues to provide the wind power plant 2 with steady active and reactive power support. When spinning reserve capacity is required, the wind turbine controller 52 receives a request to stop power production, and the process moves to step 118, which corresponds to t8 on FIG. 4.

In response to the stop production request, the wind turbine controller 52 disables the converter drive modules 54, 56, thereby disabling, or rendering inactive, the associated converters 40, 42. At this point, too, the DC-link 44 may also be allowed to drop to a predetermined voltage level that is proportional to the actual grid voltage level, and the process returns to step 106 where the wind turbine generator 4 is in a production-ready, low loss spinning reserve, state. It should be noted here that the DC-link is maintained or controlled at a charged state so that it is prepared for production to resume. In this situation the control is passive since the DC-link voltage simply drops slightly to a level which is proportional to the grid voltage, although embodiments are envisaged in which the grid voltage may be controlled actively to stay at a predetermined voltage level. Therefore, the terms ‘controlled’ and ‘maintained’ in this context should be interpreted accordingly to refer to a situation where the DC-link voltage is kept at an operational voltage level either passively or actively.

In the above approach, transitioning between an operating state and a production-ready state is achieved simply by disabling and enabling the power converters 40, 42, as required, whilst the DC-link 44 remains at a charged operational level and the grid-side and the generator-side breakers 34, 36 remain closed. The timescale for disabling or enabling the converters 40, 42 is very short, in the region of less than a millisecond and gaining power control in the range 5-10 ms, so it will be appreciated that the wind turbine system 20 can be rapidly transitioned to a state where it can provide active/reactive power. This improves the support the wind turbine system 20 can provide to the grid 6 compared to other known approaches discussed above.

Having described a scenario in which the method is used to provide the wind power plant 2 with a rapidly responding spinning reserve, the discussion will now explain a different scenario in which the control method is implemented during a low wind situation.

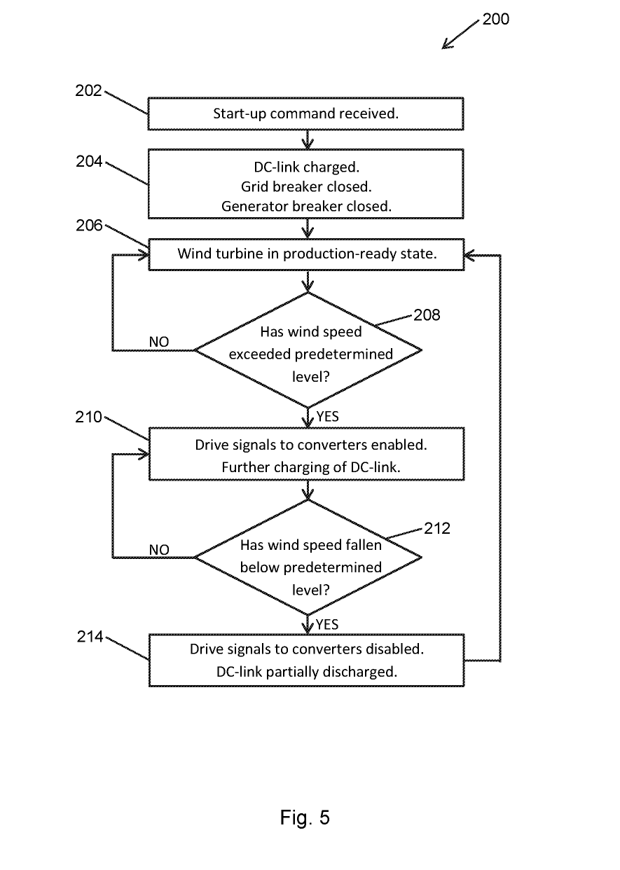

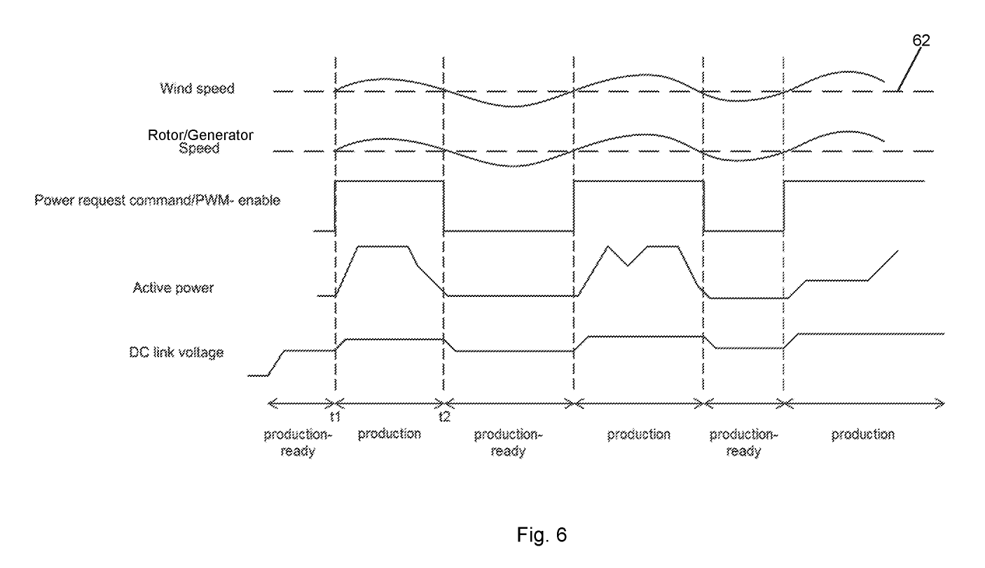

FIGS. 5 and 6 illustrate a second embodiment of the invention, in which the control method is implemented during a low wind situation where the speed of the wind varies about a threshold level, labelled as 62 in FIG. 6. Above the threshold level 62 the wind speed is sufficient for energy production, but below the threshold level 62 the wind speed is insufficient for energy production. In this scenario, it is important for the wind turbine system 20 to be ready for energy production as soon as possible after the wind speed exceeds the threshold level 62.

With reference to FIG. 5, the process 200 is initiated by the wind turbine controller 52 receiving a start-up command at step 202. At step 204, following receipt of the start-up command, the wind turbine controller 52 transmits control signals to initiate charging of the DC-link 44 to a predetermined level by the DC-link pre-charge unit 48, and to control the grid-side and generator-side breaker arrangements 34, 36 in a closed state.

At step 206, operational data is continuously received by the wind turbine controller 52 from sensors on the wind turbine generator 4 and the rotor speed is controlled such that the wind turbine system 20 is in a production-ready state where it is ready to provide active and reactive power support to the wind power plant 2.

At decision step 208 the wind turbine controller 52 monitors wind speed information received from sensors on the wind turbine generator 4 to determine if the threshold level 62 has been exceeded. If the wind turbine controller 52 detects that the wind speed has not exceeded the predetermined threshold level 62, the process returns to step 206 and the wind turbine system 20 remains in a non-operating, production-ready, state. However, when the wind speed exceeds the predetermined threshold level 62, the process moves on to step 210, which corresponds to t1 on FIG. 6. At this point, the wind turbine controller 52 responds by enabling the converter control modules 54, 56 to control energy transfer across the associated converters 40, 42 and the DC-link 44 undergoes further charging.

Thereafter, the process enters a monitoring stage, shown at decision step 212, in which the wind turbine controller 52 monitors for a drop in wind speed below the threshold level 62. The process loops around steps 210 and 212 until the wind speed falls below the threshold level 62, at which time the process moves to step 214, which corresponds to t2 on FIG. 6.

In response to the wind speed falling below the threshold level 62, the wind turbine controller 52 recognizes this as a shutdown or pause event and so disables the converter drive modules 54, 56, thereby disabling the associated converters 40, 42. The DC-link 44 is partially discharged to a predetermined level that is proportional to the actual grid voltage level and the process returns to step 206 where the wind turbine generator 4 is in a production-ready state.

As already discussed, the method of the embodiments of the invention allows the wind turbine system 20 to be rapidly transitioned between an operating state and a production-ready state, simply by disabling and enabling the power converters 40, 42, as required, whilst the DC-link 44 remains at a charged operational level and the grid-side and the generator-side breakers 34, 36 remain closed. When used in a low wind situation, as described above, this approach allows the maximum possible energy to be harnessed and improves the support the wind turbine system 20 can provide to the grid 6 during this scenario.

A further benefit of this approach is that it reduces the frequency of use of the grid-side and generator-side breakers. Frequent cycling of the breakers causes them to wear gradually and so reducing their frequency of use extends their serviceable life considerably. This is a major benefit particularly when wind turbine generators are in off shore locations where maintenance is a much more difficult and expensive process.

The skilled person will appreciate that various modifications may be made to the specific embodiments described above without departing from the inventive concept as defined in the claims.

For example, the wind turbine system 2 in FIG. 2 includes a generator-side breaker arrangement 36 and also a grid-side breaker arrangement 34. However, in some systems it is known to only have a grid-side breaker arrangement. The inventive concept discussed here is applicable to the alternative system which has no generator-side breaker arrangement.

1. A method for controlling a wind turbine system including an electrical generator, a power converter system including a DC-link, and at least a grid-side breaker arrangement controllable between open and closed states, wherein the method comprises:
monitoring for a shutdown event and, in response to identifying the shutdown event, controlling the wind turbine system into a production-ready state, comprising:
i) controlling the grid-side breaker arrangement in the closed state;
ii) disabling one or more drive signals to the power converter system; and
iii) maintaining the DC-link of the power converter system in a charged state.

2. The method of claim 1, wherein following the shutdown event, the method further includes monitoring for a start-up event and, in response to identifying the start-up event, controlling the wind turbine system into an operating state, comprising:
i) controlling the grid-side breaker arrangement in the closed state and
ii) enabling one or more drive signals to the power converter system.

3. The method of claim 1, wherein the shutdown event is triggered by a low wind condition.

4. The method of claim 3, wherein the startup event is triggered during a low wind condition.

5. The method of claim 1, wherein the shutdown event is triggered by a spinning reserve requirement.

6. The method of 1, wherein disabling one or more drive signals to the power converter system comprises disabling a pulse-width modulated drive signal to a generator-side converter and to a grid-side converter of the power converter system.

7. The method of claim 1, wherein enabling one or more drive signals to the power converter system comprises enabling a pulse-width modulated drive signal to a generator-side converter and to a grid-side converter of the power converter system.

8. (canceled)

9. (canceled)

10. A wind turbine system comprising an electrical generator, a power converter system including a DC-link, a grid-side breaker arrangement controllable between open and closed states, and a control system configured to control the wind turbine system from an operating state to a production-ready state by:
i) controlling the grid-side breaker arrangement in the closed state;
ii) disabling one or more drive signals to the power converter system; and
iii) maintaining the DC-link of the power converter system in a charged state.

11. The wind turbine system of claim 10, wherein the control system is configured to further control the wind turbine system from a production-ready state to an operating state by:
i) controlling the grid-side breaker arrangement in the closed state and
ii) enabling one or more drive signals to the power converter system.

12. The wind turbine system of claim 10, wherein the power converter system comprises a generator-side converter and a grid-side converter coupled to one another by the DC-link.

13. A computer program product on a machine readable medium, comprising program code instructions which, when executed, perform an operation for controlling a wind turbine system including an electrical generator, a power converter system including a DC-link, and at least a grid-side breaker arrangement controllable between open and closed states; wherein the operation comprises:
monitoring for a shutdown event and, in response to identifying the shutdown event, controlling the wind turbine system into a production-ready state, comprising:
i) controlling the grid-side breaker arrangement in the closed state;
ii) disabling one or more drive signals to the power converter system; and
iii) maintaining the DC-link of the power converter system in a charged state.

14. The computer program of claim 13, wherein following the shutdown event, the method further includes monitoring for a start-up event and, in response to identifying the start-up event, controlling the wind turbine system into an operating state, comprising:
i) controlling the grid-side breaker arrangement in the closed state and
ii) enabling one or more drive signals to the power converter system.

15. The computer program of claim 13, wherein the shutdown event is triggered by a low wind condition.

16. The computer program of claim 14, wherein the startup event is triggered during a low wind condition.

17. The computer program of claim 13, wherein the shutdown event is triggered by a spinning reserve requirement.

18. The computer program of claim 13, wherein disabling one or more drive signals to the power converter system comprises disabling a pulse-width modulated drive signal to a generator-side converter and to a grid-side converter of the power converter system.

19. The computer program of claim 13, wherein enabling one or more drive signals to the power converter system comprises enabling a pulse-width modulated drive signal to a generator-side converter and to a grid-side converter of the power converter system.
